(19) United States
(12) Patent Application Publication
(10) Pub. No.: US 2008/0090945 A1
(43) Pub. Date: Apr. 17, 2008

(54) POLYAMIDE COMPOSITION WITH IMPROVED HEAT STABILITY AND WHITENESS

(75) Inventors: C. Richard Langrick, Middlesbrough (GB); John F. Buzinkai, Chattanooga, TN (US); Wai-Shing Yung, Charlotte, NC (US); Ketan G. Shridharani, Charlotte, NC (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: INVISTA NORTH AMERICA S.A R.L., Wilmington, DE (US)

(21) Appl. No.: 11/857,875

(22) Filed: Sep. 19, 2007

Related U.S. Application Data
(60) Provisional application No. 60/846,078, filed on Sep. 19, 2006.

(51) Int. Cl. C08K 5/34; C08G 69/26; C08K 3/22; C08K 5/52; C08K 5/00

(52) U.S. Cl. 524/94; 524/145; 524/176; 524/413; 524/606

(57) ABSTRACT

A polyamide composition, which includes an optical brightener together with an anti-oxidant stabilizer, is disclosed. This composition is suitable for making yarns, such as sewing thread, and fabrics, garments, molded articles or other articles such as carpets from these yarns. Processes for incorporating optical brighteners into polyamide compositions, polymers and yarns to make fabrics and molded articles that exhibit superior whiteness after heat-setting are also disclosed.

### CROSS REFERENCE TO RELATED APPLICATIONS

This application claims the benefit of priority from U.S. Provisional patent application No. 60/846,078, filed on Sep. 19, 2006, which is incorporated herein by reference.

### BACKGROUND OF THE INVENTION

1. Field of the Invention

This invention relates to improved synthetic polyamide compositions and yarns made therefrom. More particularly the invention relates to a polyamide composition which includes an optical brightening agent and an anti-oxidant stabilizer, and yarns made from such compositions. The invention further relates to processes for manufacturing optically brightened polyamide compositions and yarns, and to dyed fabrics made from such yarns. The invention also relates to a process for making a heat-set polyamide fabric of superior whiteness, and to a process for the manufacture of molded articles of superior whiteness.

2. Description of the Related Art

The appearance of fabrics from synthetic polyamide yarns after dyeing is dependent on a host of process factors which often conspire to degrade the fabric appearance. A notable appearance defect after dyeing is fabric color stripes, also called streakiness. This defect is due mostly to variations in the numbers of dye sites in the synthetic polyamide polymer varying along the length of an individual multifilament yarn or varying from yarn to yarn. Dye sites in synthetic polyamide yarns are the amine end groups (AEG) in the case of traditional acid dyes. Dye sites originally present in the synthetic polymer can be lost in the course of filament melt spinning. Exposing synthetic polyamide polymer filaments, yarns and fabrics to harsh environmental conditions is known to degrade dye sites. These harsh conditions include high temperatures, atmospheric oxygen, ambient short wavelength light, and atmospheric oxidation agents from smog such as nitrogen oxides, hydroperoxy radicals, peroxyacetyl radicals and the like.

Substantially all synthetic polyamide yarns and fabrics are given some form of heat treatment which confers dimensional stability and certain desired properties. More particularly, fabrics from synthetic polyamide yarns which also contain spandex (elastane) filaments are always heat treated. In either case, these heat treatments known as “heat setting” in the art, are performed prior to fabric dyeing. Generally, heat treatments and setting employ one of the techniques of hot air setting, infrared radiant heat setting, hot roll or calender setting, or batch autoclave setting with high pressure steam. Superba and Suessen heat setting are an example for carpet fiber application.

A correlation is known to exist between a loss of polymer amine end groups, the dye sites involved with the anionic dyes for nylon, and the lighter-dyeing fabrics with an uneven striped appearance. Amine end group losses as measured in fabrics before and after heat treatment of the fabric and prior to a dyeing process are well-known (see GB patent number 1042217). This patent document discloses nylon yarns protected from amine end loss with Cu (added as a salt, e.g. acetate) and potassium iodide (KI). As a result, nylon fabrics from 3 denier (3.3 decitex) per filament yarns heat set on a stenter frame at 210° C. for ½ minute are protected from striped appearance as measured by the standard deviation in shade after diagnostic dye measurements. The standard deviation changed from 3.4 for the striped fabric to 0.8 for a fabric of GB 1042217 protected with 5 ppm Cu and 400 ppm KI. Before and after heat set the comparison fabric lost 21.8 amine end groups while the fabric of GB 1042217 lost only 5.9 amine end groups. In all examples reported in GB1042217, the nylon fabric was made from a slow speed spun (ca. 1200 meters per minute) and split process drawn yarn. These were conventional spinning conditions for 1964.

The problem of fabric color stripes is even worse for yarns having a more open molecular structure. Such yarns are produced by the methods of modern higher speed spinning, where spinning speeds over 4800 meters per minute are commonplace. Especially in partially oriented yarns (POY) and the textured yarn made from them, as well as, from fully drawn yarns (FDY), unevenly dyed color striped fabric is still a problem. It is thought that atmospheric oxygen and oxidants previously mentioned or other contaminants catalyzing yarn degradation diffuse more easily into the more open structure of high speed spun nylon yarns.

Another problem for modern high speed spun nylon yarns is found more prevalently among finer decitex multifilament yarns. It is known that dyed color yields obtained for finer decitex (dtex) yarns and especially microfilament (microfiber) is worse. The microfiber yarns of today have an individual filament titre in the range of one (1) dtex and less, down to about 0.3 dtex. Less than about 0.3 dtex titre range is normally called “ultra microfiber”; see: Chemiefasern Textilind. 42/94, pages 877-880, November 1992. It is known in the art, vide supra, that as the individual filament diameter decreases, the surface area to volume ratio of the filament increases. More light is reflected from the finer filament surface as a consequence. In dyeing practice, this means that the same content of dye in finer filaments yields a lighter color shade.

Polyamide fabrics containing spandex (e.g., Lycra®), the INVISTA S. á.r.l. registered trademark for branded polyurethane fibers) are heat-set before dyeing, at up to about 200° C. for about 1 minute. Since spandex containing yarns are used more commonly today in weft-knit and woven constructions, it is essential to heat set such fabrics on a stenter frame to ensure freedom from edge curling and to remove creases. Dye striped fabrics can result from this heat setting. Typically, a non-uniform amine end loss from one yarn to another gives rise to an appearance defect. To avoid such problems, the nylon yarn manufacturers incorporate anti-oxidants in their polyamide yarns. For this purpose, commonly used additive systems based on hindered phenols, with or without various phosphorus compounds are known remedies. The “copper/halide” anti-oxidant system mentioned above, is effective both for strength retention and for avoiding the dyeing problems outlined above. Copper/halide is used in both the older two-stage slower spinning processes and the newer high-speed FDY and POY yarns. Products derived from these yarns such as air-jet and false-twist textured yarns benefit equally well.

The copper/halide system is a family of additives of great versatility. As a result, copper/halide may be incorporated during the polymer manufacturing stage or added as a masterbatch at spinning, such as an extruder additive. Copper addition may be performed as the halide (iodide, bromide, chloride, or thiocyanate) or added in some other form such as the salt of a carboxylic acid (e.g. acetate). Concentrations as low as 5-10 ppm are effective, although higher concentrations may provide a greater degree of protection. The halide of choice is normally an alkali metal iodide, often mixed with the less expensive bromide or chloride to save costs. Halide concentrations vary, but are typically ten times the amount of copper on a molar basis. Masterbatches in polyamide carriers (e.g. nylon 6) are commercially available means to provide copper halide additions.

A known means to increase the numbers of dye sites in fine dtex nylon yarns is disclosed in U.S. Pat. No. 5,810,890 to Marfell et al. This patent discloses the increase in AEG of fine filament nylon to not less than 60 gram equivalents per 1000 kg of polymer in combination with fiber reactive dyestuffs compositions, especially formulated to obtain deep shades for fine filaments, which confers certain benefits.

U.S. Pat. No. 5,219,503 to Boles et al. discloses means to prepare nylon yarns by high speed spinning methods, and especially yarns drawn in a separate step, for critical dyed fabric applications.

U.S. Pat. No. 5,137,666 to Knox et al. discloses means for high speed spinning of POY for textured yarn production and a preferred composition for a copolyamide yarn.

U.S. Pat. No. 6,375,882 to Marlow et al. discloses means for high speed spinning of fully drawn yarns.

U.S. Pat. No. 6,063,892 to Houser et al. discloses a spandex polymer composition and spandex yarn from the specified composition. A preferred spandex yarn disclosed therein is tailored for high efficiency heat setting. Fabrics containing the preferred spandex yarn allow the heat setting process to be operated at a lower temperature.

U.S. Pat. No. 5,230,709 to Holfeld et al. discloses a polyamide dyeing process using controlled addition of acid dyes which improves the color uniformity of dyed fabrics.

U.S. Pat. No. 6,258,928 to Baird et al. discloses a polyamide composition and treatment using the thiocyanate anion to improve the whiteness retention and color uniformity of dyed fabrics through the preservation of polymer dye sites (AEG).

Additionally, it is known that all polyamides show some discoloration upon heat treatment. This problem is especially apparent in fabrics subjected to heat setting (spandex-containing fabrics, some lingerie and in the moulding of brassiere cups) in order to confer dimensional stability.

Polyhexamethylene adipamide, or nylon 6,6 (N66) polymer-based yarns in particular, often appear slightly yellow in color when compared side by side with polycaproamide, or nylon 6 (N6), polymer-based yarns.

However, both yarns discolor when the fabrics are further heat set. Manufacturers of both N66 and N6 yarns have sought remedies for yellowing of their products and generally have relied upon topical treatments with optical brighteners. The word “topical” in this context means a treatment applied locally to the surfaces of the fabric. Topical treatment of yarns, fabrics or garments with optical brighteners is effective, but not permanent. The method of topically treating fabrics with optical brighteners is known as “padding-on.” Alternatively, yarns or fabrics may be dyed in a conventional way, using an optically brightening white dye. In yet another alternative yarns or fabrics made therefrom that are intended for white end-use application may be bleached. However, in any of these cases, the optical brightening effect is gradually lost in subsequent textile treatments like dyeing and common laundry operations.

A report published by EASTMAN Chemical Company Publication AP-27C, December 1996 (the “Eastman report”) discloses the use of an optical brightener, EASTOBRITE® OB-1 [2,2′-(1,2-ethenediyldi-4, 1 phenylene)bisbenzoxazole] with nylon 6 “fiber-grade” resins. These optical brighteners function by absorbing the ultraviolet portion of the spectrum and re-emitting light in the blue region of the visible spectrum. The blue fluorescence reduces the appearance of yellow color in the material containing the optical brightener. The EASTMAN report discusses blending powdered optical brighteners (a triazine type, coumarin type, benzoxazole type, stilbene type and OB-1) with two polyamide nylon 6 resins. These resins were a first delustered resin containing 0.3% titanium dioxide and a second resin with 1.6% titanium dioxide. These nylon 6 resins were 3 millimeter mesh size and dry blended with the brightener compositions. The differently optically brightened nylon 6 resins were spun into drawn yarns and knitted to make fabrics which were scoured prior to lightfastness and whiteness measurements. The EASTMAN report also discusses blending a brightener with molten nylon 6,6 in a wet, oxygen free atmosphere to “simulate production conditions.” The EASTMAN report states that EASTOBRITE OB-1 was “stable and retained its fluorescence” in this blend. However, no fiber spinning results or whiteness data were reported for nylon 66. Also not reported in the EASTMAN report, for any polyamide, were the important fiber properties of tensile strength and light fastness or protection of NH2 ends.

Prior art remedies to retain whiteness of synthetic polymer based yarns and fabrics, especially remedies sought for improving nylon 6,6 “fabric whiteness,” are not adequate for commercial manufacturing processes. As noted above, the conventional bleaching, padding or dyeing techniques are expensive and do not retain their activity over time. As such, a need still exists for incorporating optical brighteners into synthetic polyamide polymers to achieve a permanent whiteness improvement in either yarns or fabrics made therefrom where such whiteness improvement is unaffected by fabric post-processing, such as heat setting. Furthermore, the methods of bleaching, padding-on and white-dyeing are limited to white fabrics; it is highly desirable to find a method which will produce a good white fabric which can then be dyed subsequently to give cleaner brighter colors.

### SUMMARY OF THE INVENTION

Applicants found that yarns made from synthetic polyamide compositions can be improved in whiteness appearance by incorporating an optical brightener agent (also referred to herein as “optical brightening additive” or “optical brightener”) into the yarn itself. Such yarns exhibit a permanent whiteness improvement and can retain this whiteness improvement through operations such as heat setting. In certain cases, they also result in a cleaner, more intensely colored fabric when the fabric is dyed. This effect on colored fabrics cannot be achieved through conventional optical brightening techniques, as the brightener is removed from the fabric during the dyeing process. In addition, the polyamide compositions of this invention include an anti-oxidant stabilizer. Thus, the compositions, the yarns, the fabrics made from the yarns and any articles made from the fabrics are unique in that they not only provide better dye uniformity but also cleaner and whiter appearing yarns, fabrics and articles than what is currently available.

According to an aspect of the invention, there is provided a polyamide composition, which comprises polyhexamethylene adipamide, polycaproamide, or blends or copolymers thereof, the polyamide composition further including (i) an optical brightener agent; and (ii) an anti-oxidant stabilizer comprising: (A) a copper halide antioxidant system and and/or (B) an organic antioxidant. The polyamide composition may comprise other moieties, such as other diamines (e.g., 2-methyl pentamethylene diamines), diacids (e.g., isophthalic acid, 5-sulfoisophthalic acid sodium salt), and/or lactams (e.g., lauryl lactams) included in the amount of less than 30% by weight of the polyamide composition.

In one aspect, the invention is directed to a yarn, such as a textile yarn, comprising at least a single filament including the polyamide composition of this invention. Yarns that are within the scope of the invention include a low oriented yarn, partially oriented yarn, fully drawn yarn, flat drawn yarn, draw textured yarn, air jet textured yarn, bulked continuous filament yarn, staple and tow, that have tenacity in the range of about 2 to about 12 gram/denier and elongation in the range of about 5 to about 90%. All yarns described herein are used in applications that include, but are not limited to, apparel, industrial filament, sewing thread, and carpeting. One embodiment of a yarn encompassed by the invention includes a yarn comprising the polyamide composition of the invention having a b-colour in the range of −5 to −15 on the b* axis of the CIE rating.

Yarns and fabrics made from yarns, as well as articles of manufacture, such as garments, made from such fabrics, which may also be heat set fabrics, fall within the scope of the invention. All articles of manufacture encompassed by the invention may be comprised partially of the polyamide composition (and/or yarns) of the invention, with the remainder being a different composition (and/or yarns). Conversely, such articles of manufacture may be comprised exclusively of the polyamide composition (and/or yarns) of the invention.

These and other features and attributes of the compositions and processes discussed herein and their advantageous applications and/or uses will be apparent from the entire description, including detailed description and claims.

### DETAILED DISCLOSURE OF THE INVENTION

The terms “yarn” and “thread” are used interchangeably herein to refer to the same article.

When numerical lower limits and numerical upper limits are listed herein, ranges from any lower limit to any upper limit are contemplated.

All numerical values herein are understood to be modified by “about”, unless explicitly stated otherwise.

In this application the terms “comprise”, “include”, variations or derivatives thereof are used to define contents of compositions, definitions of a process or method. It is understood that with respect to such compositions, process or method, we also intend to include in this application, and reserve the right to define such compositions, process or method with, alternative terms, such as “consists essentially of, “consists of”, variations or derivatives thereof.

In accordance with the general aspects of the invention, a polyamide composition is provided comprising an optical brightener together with an anti-oxidant stabilizer.

The polyamide composition may be polyhexamethylene adipamide or polycaproamide, or copolymers thereof but is not limited to these polymers and copolymers. These nylon polymers and copolyamides are inherently dyeable by acid, reactive and disperse dyes in particular.

The optical brightener agent (also referred to herein as “optical brightening agent”, “optical brightening additive (OBA)” or “brightener”) includes at least one of but is not limited to the following brighteners: a triazine type (e.g. Tinopal AMS-GX available from Ciba Specialty Chemicals, benzenesulfonic acid, 2.2′-(1.2-ethenediyl)-bis[5-[[4-(4-morpholino)-6-(phenylamino)-1.3.5-triazine-2-yl]-amino], disodium salt [CAS 16090-02-1], a distyrylbiphenyl type (for example UVITEX® NFW available from CIBA Specialty Chemicals Inc, CAS 27344-41-8), a thiophenediylbisbenzoxazole type (for example UVITEX® OB available from CIBA Specialty Chemicals Inc, CAS 7128-64-5), a coumarin type (e.g., Coumarin 1 available from Acros Organics, 7-diethylamino-4-methylcoumarin [CAS 91-44-1]), a bisbenzoxazole type (e.g., those in the Eastman report), a stilbene type (e.g., UVITEX OB-ONE available from Ciba Speciality Chemicals, 4,4′-Di(benzoxazol-2-yl) stilbene [CAS 1533-45-5] and 2,2′-(1,2-ethenediyldi-4,1-phenylene) bisbenzoxazole. Other suitable brighteners are known in the art, e.g., as described in Kirk-Othmer Encyclopedia of Chemical Technology, 4^{th} Edn. Ex.Ed J I Kroschwitz Ed M Howe Grant; John Wiley Volume 11, Fluorescent Whitening Agents; Plastic Additives Handbook, 4^{th} Edn, Ed R Gachter and H Müller; Hanser; Chapter 14 Fluorescent Whitening Agents, and Ullmans Encyclopedia of Industrial Chemicals 7^{th} Edn, John Wiley; Optical Brighteners, A E Siegrist, C Eckhardt, J Kaschig, E Schmidt, all of which are incorporated herein by reference. Persons of ordinary skill will be readily able to identify such brighteners. The composition comprises about 5 to about 2,000, such as about 50 to about 300, typically about 200 parts per million (ppm) by weight of at least one optical brightener or a mixture thereof, based on the total weight of the composition.

In one embodiment the polyamide composition includes the optical brightener 2,2′-(1,2-ethenediyldi-4,1-phenylene) bisbenzoxazole present in an amount of about 2 to about 2,000, such as about 50 to about 300, typically about 200 parts per million by weight, based on the total weight of the composition.

The anti-oxidant stabilizer (also referred to herein as an “anti-oxidant”) may be a copper halide antioxidant system, an organic antioxidant or a combination thereof. The copper halide antioxidant system may be any of the well known in the art copper halide antioxidants, for example and without limitation, it may be copper iodide; copper bromide; copper acetate with or without halide ion source, such as potassium iodide and/or potassium bromide. The organic antioxidant may be, for example hindered phenols, such as and without limitation to, N,N′-hexane-1,6-diylbis (3-(3,5-ditertbutyl-4-hydroxyphenylpropionamide) [CAS 23128-74-7]; or phosphorus based organic antioxidants known to be used with polyamides, for example and without limitation to, potassium tolylphosphinate [CAS 208534-39-8]; sodium phenylphosphinate [CAS 4297-95-4] or tris (2,4-ditert-butylphenyl) phosphate [CAS 31570-04-4]. The polyamide composition comprises about 5 ppm Cu to about 100 ppm Cu, typically about 10 ppm Cu to about 65 ppm Cu by weight, for the copper halide antioxidant stabilizer and/or about 50 ppm to about 1000 ppm organic antioxidant, typically about 200 ppm to 800 ppm for the organic anti-oxidant stabilizers, based on the total weight of the composition. It is to be understood that combinations of any antioxidants are also contemplated herein.

Further in accordance with the invention, there is also provided a process for producing a heat-set nylon fabric of satisfactory whiteness, comprising: constructing a fabric from an optically brightened nylon yarn of the invention, heating the fabric to a temperature in the range of about 160° to about 220° Celsius for a period of about 20 seconds to about 90 seconds, to produce the fabric having a CIE whiteness (W) of at least 75(W), measured after heat-setting. The fabrics exhibit noticeably improved and substantially permanent whiteness, which is retained in the fabrics even after subsequent processing, such as heat setting. Yarns made from the polyamide composition that are not converted into fabrics and therefore do not undergo such fabric-post processing may exhibit a b-colour reduction in the range of 1 to 20, preferably more than 2 units on the b* axis of the CIE rating.

Further provided in another aspect is a process for manufacture of a molded article, such as a brassiere cup of improved whiteness. In such a molding process a fabric made with an optically brightened nylon yarn is subjected to heat and pressure in a mold for a pre-determined time.

In an aspect of the invention, there is provided a polyamide composition (as discussed above) which includes an optical brightener. The polyamide composition may comprise an acid-dyeable polymer or a base dyeable polymer (also known as cationic modified polymer). The polyamide composition may typically include either polyhexamethylene adipamide (nylon 6,6), or polycaproamide (nylon 6), or blends or copolymers of either of these or other polyamides and copolyamides. The optical brightener is present in an amount of about 5 to about 2,000, such as about 50 to about 300, typically about 200 ppm by weight of the optical brightener or a mixture of brighteners.

The polyamide composition of the invention may be made by adding the optical brightening additive (OBA) before, during or after polymerization. That is to say, the OBA may be introduced with the monomeric materials themselves (hexamethylene diamine and adipic acid in the case of nylon 6,6; or caprolactam in the case of nylon 6), or while those monomeric materials are being processed into a polymer, or introduced into the molten polymer once the polymerization process is completed. Alternatively, the OBA may also be compounded at a higher concentration into a masterbatch by the use of a carrier polymer, after which polymer granules of this masterbatch are metered into conventional polymer prior to melting, mixing and extruding into filaments. Alternatively, masterbatch concentrate or the pure OBA may be melted and fed as a separate stream into the normal molten polymer flow, as opposed to mixing the solid granules, for subsequent mixing and extrusion.

Specifically, the polyamide composition may be made by an autoclave process. In this process a concentrated aqueous solution of nylon 6,6 salt may be provided to an autoclave vessel. The solution may be prepared from an aqueous solution of the monomers hexamethylene diamine and adipic acid, in the manner known in the art. Optionally, the solution may also contain minor amounts of other co-monomers, such as diamines, dicarboxylic acids, or nylon 6 monomer as a caprolactam solution. The optionally added co-monomers may be mixed with the nylon 6,6 salt in an amount to provide a final copolymer content of about 0.1 to about 20 percent by weight. Antioxidants may be added at this or another stage in the process, for example aqueous solutions of copper acetate and potassium bromide and/or potassium iodide may be added to the salt mixture, typical levels in the final polymer would be aiming for 5-100 ppm copper with an appropriate level of halide ion well known in the art. The autoclave vessel may then be heated to about 220° C. allowing the internal pressure to rise. Other additives such as the delusterant, titanium dioxide (TiO₂), may optionally be injected as an aqueous dispersion into the autoclave at this point. In order to provide an optically brightened polymer, an aqueous dispersion or solution of an optical brightener may also be injected into the mixture in the autoclave vessel at this same point. Alternatively, the optical brightener may be added as an aqueous dispersion or solution or a dispersion or solution in an organic solvent, such as caprolactam, when the concentrated salt solution is first introduced into the autoclave. Alternatively, the optical brightener may have been included when the salt solution was first prepared, prior to concentration and introduction into the autoclave or injected into the polymer melt. The mixture may then be heated in the autoclave to about 245° C. While at this temperature, the autoclave pressure may be reduced to atmospheric pressure and may also be further reduced in pressure by application of a vacuum in the known manner, to form the polyamide composition. The autoclave, so containing the polyamide composition, would typically be maintained at this temperature for about 30 minutes. This step may be followed by further heating of the polyamide polymer composition in the autoclave to about 285° C. and introducing dry nitrogen to the autoclave vessel and pressurizing the autoclave to about 4 to about 5 bar absolute pressure.

The polymer composition may be released from the autoclave by opening a port in the autoclave vessel and allowing the molten polyamide composition to flow from the vessel in the form of laces. These laces may be cooled and quenched in a current of water. Next, the laces of polyamide polymer may be granulated by known means and further cooled with water. It should also be understood that without limitation other additives well known in the art may also be added into these processes, for example UV Stabilisers.

Alternatively, the composition may be prepared by a continuous polymerization (CP) route. For nylon 66 and its copolymers, the essential process steps are similar to the autoclave process. A concentrated solution of Nylon 66 salt and appropriate comonomers is introduced to a pre-polymerizer unit, where most of the water is removed, and the mass polymerizes to a polymer of low molecular weight. The melt then passes down heated tubes and emerges as a higher molecular weight polymer from which the steam can be removed in a separator unit. The molten polymer may then be extruded as laces, cooled in water and cut into granules suitable for drying, optionally increasing the degree of polymerization in the solid phase, and remelting for subsequent spinning.

Alternatively, the CP line may be connected to a spinning machine, so that direct spinning is possible, without passing through the intermediate steps of cooling and cutting to granules.

As in the batch process, the optical brightener and the antioxidant stabilizer may be introduced at several different points, preferably as an aqueous dispersion or solution. Thus the optical brightener may be added to the original salt solution before concentration, or introduced into the first stage of polymerization at the same time as the concentrated salt solution, or injected further downstream into the melt, or even injected in the molten state into the final emerging polymer stream. Masterbatch additive of brightening agent can also be used by remelting the additive and injecting into polymer melt further down the process such as in polymer transfer line.

Nylon 6 and its copolymers are almost always produced by a CP route, in which caprolactam, small amounts of water, and an initiation catalyst such as acetic or benzoic acid are fed together with comonomers and additive slurries such as titanium dioxide, into the CP polymerizer.

Alternatively, the polyamide composition of the present invention may be made by a masterbatch process, in which a high concentration of optical brightening agent, for example 1-10% by weight, is incorporated into a suitable carrier polymer, preferably a polyamide. Such a masterbatch may be manufactured by any of the methods outlined above, provided that the appropriate concentration of the additive (i.e., the optical brightening agent) can be attained. However, it is more typical to use a compounding process, in which predetermined amounts of the powdered additive and carrier polymer are mixed, melted together in an extruder, extruded into laces, cooled by water and cut into granules. Subsequent blending of the granules gives a concentrate that is uniform throughout.

If the masterbatch is used, the concentrated masterbatch may then be either mixed with normal polymer granules (the base polymer) via a metering system, and the two melted together to give the composition of the invention, or the masterbatch may be melted separately, and then injected into the flow of molten standard polymer. Various scenarios can be envisaged and are incorporated herein without limitation, for example, a masterbatch of the optical brightener may be added to a base polymer containing the antioxidant system, or a masterbatch of the optical brightener and the antioxidant may be added to simple base polymer, or separate masterbatches of the optical brightener and the antioxidant may be independently added to a simple base polymer.

Where more than one ingredient is to be added, for example the optical brightening agent together with an anti-oxidant, the ingredients may be compounded together into a single polymer masterbatch.

Various alternatives may be made to the present invention without departing from the scope thereof. For instance, the optical brightener may be melted without recourse to a masterbatch, and then injected into the flow of molten standard polymer at the entrance to a spinning machine.

Alternatively, the optical brightener may be dosed in solid powdered form to a standard polymer at any stage, as may be implied in the Eastman report, but this dosing may make it difficult to control the concentration. Similarly, the antioxidant can be added to the polymer after making polymer granules in powder form or as solution sprayed on to polymer granules but before melting the polymer using an extruder or remelt system.

Alternatively, the optical brightener may be incorporated into an emulsifiable wax, which is then used to form an aqueous dispersion. The dispersion is sprayed on to polyamide polymer granules in the required amount, and then dried. The treated granules can then be melted and spun into fiber. Alternatively polyamide granules may be steeped in an aqueous solution or dispersion of optical brightener and/or antioxidant and then dried. The treated granules can then be melted and spun into fiber.

The masterbatch processes, the CP processes or the autoclave process described above can provide a polyamide composition with a formic acid method relative viscosities (RV) of about 32 to about 62 and about 45 gram equivalents of amine ends per 1000 kilograms of polymer. Optionally, either process may be modified to make a polyamide composition having about 50 to about 100 gram equivalents of amine ends, per 1000 kilograms of polymer, provided by the addition of an excess of organic diamine such as hexamethylene diamine solution to the aqueous solution of nylon 6,6 salt, or with the caprolactam feed to a nylon 6 polymerizer. In addition, the polymers may be further polymerized in a solid phase unit, to much higher viscosity levels.

The nylon polymers and copolyamides described herein are inherently acid-dyeable. The number of free amine end groups (AEG) in these polymers is at least 25 gram equivalents per 1000 kilograms of nylon polymer. In order to make the polymers more deeply acid dyeing, an enhanced level of free amine end groups is desired. More deeply acid dyeing nylon polymers have an enhanced AEG level, at least 35 gram equivalents per 1000 kilograms of nylon polymer, and AEG levels of 100 gram equivalents per 1000 kilograms of nylon polymer may be used. It is also to be understood that the cationic dyeable copolyamides with optical brighteners and antioxidant additives described in the present invention can be made by using 5-sodiosulfoisopthalic acid as a comonomer during polymerization.

The polyamide composition of the present invention is particularly useful when spun into yarns, because the optical brightener is incorporated into the composition, and hence in the yarn itself when fabric is formed, as opposed to being padded on to a fabric. The yarns of the present invention exhibit improved whiteness, especially after fabric processing, such as heat setting. A further advantage is that the optically whitened fabrics may subsequently be dyed in a conventional way, using acid dyes, reactive dyes etc., to give colored fabrics that appear cleaner, fresher and brighter than standard fabrics. This result may not be achievable through padding-on or white-dye methods, because the brightening agent comes off during the dyeing process.

Typically, the yarn of the present invention is a multifilament textile yarn in the form of either a low orientation yarn (LOY), a partially oriented yarn (POY) or a fully drawn yarn (FDY). The yarn may be a textured yarn made from partially oriented yarn, or an air jet textured yarn. Moreover, the yarn of the present invention may be substantially continuous or comprised of shorter lengths.

In one embodiment such yarns may be used to make fabrics, which in turn may be used to make garments.

In another embodiment such yarns of the invention may be bulked continuous filament yarns (BCF) or spun staple, and have utility as carpet yarns.

In a further embodiment the yarns of this invention may also be higher strength industrial yarns, where there are clear advantages in certain areas, such as clear bright-colored fabrics for hot air balloons, or in a more durable white yarn in sewing thread or shoe-laces for sportswear.

For end-use applications requiring white yarns, certain processing steps, such as bleaching, padding on, and white dyeing, that are typically used to correct deficient levels of whiteness in conventional optically brightened polymers may be eliminated when the yarns made from the polyamide of this invention are used.

It should be further appreciated that for certain white end-use applications where the wound yarn packages may be bleached, padded on, or white dyed, for example in sewing threads, non-uniformity in whiteness through the package, prepared by conventional, previously known methods, is a well known problem. The cause of this non-uniformity is excessive shrinkage of the yarn package when exposed to bleaching or dyeing conditions, thereby leading to a compacted package which can restrict dye liquor or bleach flow resulting in unlevel bleaching or dyeing. In order to avoid such non-uniformity, it is known in the art that such yarns must be produced according to stringent shrinkage specifications, typically less than or equal to about 5.5% as determined by the Testrite shrinkage method.

For white yarn applications where the subsequent manufacture of fabric and the use of fabric post processing steps, such as heat setting, are not required, use of the polyamide composition and yarns of this invention may allow the yarn shrinkage specification to be eliminated or at least relaxed. Thus, in accordance with the invention, there is provided a white yarn product that can exhibit yellowness reduction of about 2 to about 25 units on the b* axis of the CIE rating.

In one embodiment, the invention is also directed to a process for manufacturing a sewing thread comprising several steps. In a conventional, heretofore known process for manufacturing sewing thread, before the commencement of such process, a multi-filament thread line is prepared. As the nylon is spun, multiple nylon filaments are co-alesced into the multi-filament threadline, which is wound onto a suitable device, such as a package or a bobbin (which may be referred to herein collectively as a “package”). The package or bobbin is provided to a sewing thread manufacturer. The next step is twisting and plying usually carried out by the manufacturer. The initial twisting stage consists of twisting together fine continuous fibers, having at least 3 denier per fiber, in each threadline. This produces the coherence and strength combined with flexibility which is essential in any good sewing thread. The twist inserted into the yarn provides the consolidating force. Twist is defined as the number of turns inserted per meter of yarn or thread produced. Plying, conducted after the twisting, involves combining two or more multifilament threadlines (plies) to form the thread construction. This process is referred to as the finishing twist.

Next, the yarn is usually scoured to remove the spin finish that has been applied to the filaments. Scouring is usually conducted with a non-ionic low foam detergent or a non-ionic low foam detergent and soda ash or tetrasodium pyrophosphate at elevated temperatures. Subsequently, the yarn is dyed or bleached.

Successful package bleaching or dying (at high or low temperature) requires careful attention to package formation, package size and package density. These factors are of particular importance when bleaching or dyeing fibres with significant shrinkage as the shrinkage may result in a hard, dense package, which may restrict dye liquor or bleach flow resulting in unlevel bleaching or dyeing.

The final stage in the conventional sewing thread manufacturing process involves applying a resin to the thread to bond the thread (i.e., different threadlines) for protection during sewing applications. One suitable resin is Elvamide nylon resin, usually applied to the thread from a solvent solution, usually methanol, of 4-18% solids in a dip through process.

In order to ensure uniform bleaching (or dying), the yarn must exhibit low shrinkage (typically<5.5% as determined by the Testrite shrinkage method). Higher shrinkages would cause the yarn packages to compress during the bleaching or dying process, thereby impeding uniform penetration of the bleach or dye through the interior of the wound yarn package. Additional details of the conventional process for manufacturing sewing thread (and other threads) are described in “The Technology of Threads & Seams”. Produced by Jane Hunnable, Coats Marketing, London 1996, incorporated herein by reference.

The principal method for determining yarn shrinkage is the Testrite shrinkage method. According to the method, a relaxed, conditioned specimen of yarn or cord is subjected under tension of 0.05+−0.01 grams/denier to dry heat at a temperature of 177° C. for a period of 2.0 minutes. The shrinkage (%) is read from a scale on the instrument, while the specimen is exposed to heat and tension. The Testrite shrinkage method is further described in ASTM D 885, Section 30.3 (1), (Shrinkage of Conditioned Yarns and Cords at Elevated Temperature) and ASTM D 4974 (Standard Test Method for Hot Air Thermal Shrinkage of Yarn and Cord Using a Thermal Shrinkage Oven).

In contrast, sewing thread is made in the process of our invention by omitting the dyeing or bleaching, and possibly the scouring operations. Thus, this process comprises (or consists essentially of): (i) providing a wound package of a multi-filament nylon thread; (ii) twisting multiple times the multi-filament nylon thread to form a larger bundled threadline; (iii) plying 2 or more of the bundled threadlines to produce the sewing tread; (iv) optionally scouring the sewing thread; (iv) applying a bonding agent to the sewing thread; and (v) rewinding the sewing thread onto a bobbin or bobbins. In one embodiment, the sewing thread produced by this process has a b-colour in the range of −5 to −15 on the b* axis of the CIE rating.

The multi-filament nylon thread provided on the wound package may comprise any of the polyamide compositions of the invention, discussed herein, e.g., a polyamide composition, which comprises polyhexamethylene adipamide, polycaproamide, or blends or copolymers thereof, the polyamide composition further including: (i) an optical brightener agent; and (ii) an anti-oxidant stabilizer comprising (A) copper halide antioxidant system; and/or (B) an organic antioxidant.

The wound package of the multi-filament nylon thread is made in a conventional manner. Similarly, all the other operations/steps of our process are carried out in conventional ways, e.g., as described above and in connection with the description of the heretofore known process for making the sewing thread.

Yarns of the invention may be prepared by adapting known melt spinning process technology. With such technology, the granulated polyamide composition made by using a CP or autoclave process, both having an optical brightener and an antioxidant therein as described above, is provided to a spinning machine. The granulated polyamide composition may also contain a blend of standard polymer with a measured amount of masterbatch concentrate comprising a carrier resin with the optical brightener and optionally other additives. Alternatively, the optically brightened molten output from a continuous polymerizing unit (CP) may be coupled directly to such a spinning machine. The molten polymer is forwarded by a metering pump to a filter pack, and extruded through a spinneret plate containing capillary orifices of a shape chosen to yield the desired filament cross-section at the spinning temperature. These cross sectional shapes include circular, non-circular, trilobal and diabolo, hollow or many others. Spinning temperatures are typically in the range of 270° to 300° C. for nylon 6,6 and its copolymers, and 250° C. to 280° C. for nylon 6 and its copolymers. The bundle of filaments emerging from the spinneret plate is cooled by conditioned quench air, treated with spin finish (an oil/water emulsion), and optionally interlaced. In the case of FDY (Fully Drawn Yarn), the in-line processing on the spinning machine consists of making several turns around a set of godet rolls (feed rolls), the number of turns being sufficient to prevent slippage over these rolls, and then passing the yarn over another set of rolls (draw rolls) rotating at sufficient speed to stretch the yarn by a predetermined amount (the draw ratio), and finally heating and relaxing the yarn; for example, with a steam-box, before winding up on a take-up device. Speeds of at least 4000 meters per minute are typical of modern processes. Optionally, an alternative heating (or relaxing) method may be used, such as heated rolls, and an additional set of godet rolls may be incorporated between the draw rolls and the winder to control the tension while the yarn is set or relaxed. Also, optionally, a second application of spin finish, and/or additional interlacing may be applied before the final winding step.

In the case of POY, the additional in-line processing consists only of making a S-wrap over two godet rolls rotating at essentially the same speed, and then passing the yarn to a high speed winder, and winding at a speed of at least 3500 meters/min. Use of the S-wrap is beneficial to control tension, but not essential. Such a POY may be used directly as a flat yarn for weaving or knitting, or as a feedstock for texturing. The LOY spinning process is similar to POY except that a lower windup speed, of perhaps 1000 m/min or below is used. These low orientation yarns, in general, are further processed via a second stage, e.g., on a conventional draw-twister or draw-wind machine.

Further in accordance with the present invention, there is also provided a process for heat setting an optically brightened nylon yarn of this invention, comprising: heating the yarn to a temperature of about 1600 to about 2200 Celsius for a period of about 20 seconds to about 90 seconds, wherein the yarn has a CIE whiteness (W) of at least 75, measured after the yarn was heatset at that temperature. More typically, a heat setting temperature of 185° Celsius and a heating period of 45 seconds may be used. In this method any of the optical brightening agents included in the polyamide composition of the invention and any of the anti-oxidant stabilizers included in the polyamide composition of the invention may be included in the yarn used. For example, the anti-oxidant may be an organic substance such as a hindered phenol or phosphorus based, such as a phosphinate salt or organophosphite, or a mixture of organic substances. In an embodiment, copper ion, typically present in the amount of about 5 ppm to about 10 ppm (based on copper content) and a counter ion halide are used as the anti-oxidant with the optical brightening agent. In another embodiment, copper ion, typically present in the amount of about 60 ppm to about 70 ppm (based on copper content) and a counter ion halide are used as the anti-oxidant with the optical brightening agent.

There is also provided a process for producing an optically brightened nylon article, such as a molded brassiere cup. Such a process may be any process known in the art. For example, the process described in US 2005/0183216, incorporated herein by reference, may be used. One such process comprises introducing into a mold a previously heat-set polyamide fabric containing optically brightened nylon yarn, subjecting the previously heat-set polyamide fabric to a pressure of about 6 bar at a temperature 5 to 15° C. higher than the previous heat-setting temperature for a time period of up to 60 seconds.

Test Methods

Yarn tenacity and the yarn elongation are determined according to ASTM method D 2256-80 using an INSTRON tensile test apparatus (Instron Corp., Canton, Mass., USA 02021) and a constant cross-head speed. Tenacity is measured according to the method of ISO-2062, and is expressed as centi-Newtons per tex (cN/tex). The yarn percent elongation is the increase in length of the specimen, measured at breaking load, expressed as a percentage of the original length.

Polymer RV is measured using the formic acid method according to ASTM D789-86, but using an Ubbelohde viscometer instead of the Ostwald type.

Polymer amine end concentration is measured by directed titration with standardized perchloric acid solution of weighed polymer samples dissolved in phenol/methanol mixture. Solutions were not filtered to remove insoluble delustering pigments, but allowance was made for them: in calculating the concentrations.

Yarn whiteness was determined using a test method conforming to the CIE whiteness rating for each yarn sample. Samples were measured individually for whiteness (W) and yellowness (Y) using a GRETAG MACBETH “COLOR EYE” reflectance spectrophotometer. The measurements were carried out first, by determining the color coordinates L, a and b; and then, calculating W and Y by means known in the art (see: ASTM Method E313-1996 Standard Practice for Calculating Whiteness and Yellowness Indices from Instrumentally Measured Color Coordinates). Details of this measurement are found in Color Technology in the Textile Industry 2nd Edition, published by Committee RA 36, AATCC (1997); see in this volume: Special Scales for White Colors by Harold and Hunter, pp 140-146, and the references therein; all being incorporated herein by reference in their entirety.

### EXAMPLES

### Example 1

Optically Brightened Polymer with Antioxidant

First, yarns of optically brightened polymer are prepared. Such yarns may be melt spun in the known manner as a POY. For example, the yarns are melt spun as 68 circular cross section filaments of a total linear density of 96 dtex (96f68) using a nylon 66 polymer of 40 RV, 50 AEG (amine end groups per 1000 kilograms of polymer) containing 0.009% by weight TiO₂, together with a masterbatch of optical brightener (EASTOBRITE® OB-1 which is 2,2′-(1,2-ethenediyldi-4,1-phenylene) bisbenzoxazole, (available from Eastman Chemical Company, PO Box 431, Kingsport, Tenn. 37662, USA) in a nylon 6 based carrier resin, available in a compounded masterbatch form from Americhem Inc., 225 Broadway East, Cuyahoga Falls, Ohio 44221, USA). Such yarns may contain varying amounts of optical brightener, and therefore varying amounts of nylon 6 polymer in which the optical brightener was dispersed. Generally, such yarns may contain less than or equal to 400 parts per million EASTOBRITE® OB-1. In addition, an antioxidant, potassium tolyl phosphinate, is compounded into the masterbatch to give in yarn in an amount of generally 3 to 7 moles per million grams of polymer (moles per 10⁶ grams of polymer) which corresponds to 583 to 1360 parts per million (ppm). Less than or equal to 10 moles of the antioxidant per 10⁶ grams of polymer, i.e. 1500 ppm, is effective. These yarns, melt spun and processed as a POY, are textured and knit into yarn tubes, heat set at several temperatures in the range of 170° C. to 190° C., and then measured for yellowness using the test method conforming to the CIE rating as described above. Heat set time and temperature is chosen to simulate trade heat setting and generally in the dry condition for 30 seconds. The optically brightened composition with the antioxidant is capable of reducing the yellow appearance of the yarn versus control yarns, i.e. yarns without any optical brighteners and/or antioxidant potassium tolyl phosphinate, by about 10 units on the b* axis of the CIE rating.

As a primary control, the same nylon 66 polymer but without optical brightener is used. As a secondary control, similar yarns from nylon 6 are used without optical brightener and antioxidant. A tertiary control is nylon 66 yarn with 5 moles per million grams of polymer antioxidant, potassium tolylphosphinate, which is known to have reduced yellow color by about 3 units on the b* axis of the CIE rating.

### Example 2

Heat stability of Optically Brightened Polymer With Antioxidant

This example describes the heat stable nature of the polymer of the invention. The same yarns (96f68) as described in Example 1, may be melt spun in the known way as a POY and contain about 400 parts per million EASTOBRITE® OB-1 and an antioxidant, potassium tolyl phosphinate in an amount of generally about 5 moles per million grams of polymer (moles per 10⁶ grams of polymer). These yarns are textured and knit into tube socks and dyed using the diagnostic acid dyes known for use with nylon. In general, the ABB and MBB dyes of this type, known to skilled persons, perform well in rating nylon yarns for defects, such as non-uniform dye stripes, in critical dye applications. A critical dyestuff for this diagnostic is Nylosan Brilliant Blue N-FL (applying at 0.15% weight on fiber at pH 7). After dyeing, these tubes are heat set in the range of 170° C. to 190° C. to simulate the trade process. The controls are nylon 66 without the optical brightener and antioxidant. Heat setting at 1 min and 5 minutes reveals shade changes in the dyed article. In general, the dyed control article is faded visibly after one minute and dramatically after 5 minutes. The tubes from yarns with optical brightener and antioxidant show substantially no change in shade after heat setting and better appearance uniformity.

### Example 3

Heat Stability of Optically Brightened Polymer With Antioxidant

This example illustrates heat stable nature of the polymer of the invention. The same yarns (96f68) as described above in Example 1, may be melt spun in the known way as a POY and contain about 400 parts per million EASTOBRITE® OB-1 and an antioxidant, based upon a copper halide system, in an amount of generally about 5 to 65 parts per million (as copper). The same heat setting experiment as above in Example 2 is performed with substantially the same results. That is, the tubes from yarns with optical brightener and antioxidant show substantially no change in shade after heat setting and they show better appearance uniformity. In contrast, the controlled article is faded visibly after one minute and dramatically after 5 minutes.

### Example 4

Production of Optically Brightened Polymer

### Comparative Example 1

A copolyamide made from 97.5 wt % hexamethylenediammonium adipamide (Nylon 66 salt) and 2.5 wt % 2-methylpentamethylenediammonium adipamide and comprising 0.3 wt % titania was manufactured using methods well known in the art. Target RV was 40, actual RV was 39.4, and target AEG was 50 moles per million grams (mpmg) and actual AEG was 43.6 mpmg,

### Comparative Examples 2 and 3 and Example 4 and 5

Comparative Examples 2 and 3 and Example 4 and 5 were made to the same basic recipe as Comparative Example 1 with the addition of additives as illustrated in Table 1. Where incorporated, the final level in polymer of the copper halide antioxidant stabiliser was targeted at 10 ppm Cu (added as acetate), 60 ppm I (added as KI) and 115 ppm Br (added as KBr). Where incorporated, the final level in polymer of potassium tolylphosphinate in polymer was targeted at 3 mpmg. Where incorporated, the final level of optical brightener in polymer was targeted at 200 ppm (added as EASTOBRITE OB-1). All polymers made were within 4 RV units of target and 3 AEG units of target.

The copolyamides of Comparative Example 1 and 3 and Example 4 and 5 were processed into yarn and further constructed into fabric using methods well known in the art. The fabrics were subject to scouring and then to heat treatment under conditions as outlined in Table 1. The benefit in terms of perceived whiteness, as evidenced by b* values is shown in Table 1.

TABLE 1

| | | | | | | | | L* | b* |
|---|---|---|---|---|---|---|---|---|---|
| | | | | | | | | Fabric after being | |
| | | | | | | | | scoured then heat | |
| | Cu | Potassium | Optical | | | L* | b* | treated for 60 | |
| Example | halide | tolylphosphinate | Brightener | L* | b* | As made fabric | | seconds at 190° C. | |
| Comp 1 | no | no | no | 89 | 1.7 | 94 | 4.0 | 95 | 5.7 |
| Comp 2 | yes | no | no | 94 | 3.3 | 94 | 4.9 | 94 | 5.3 |
| Comp 3 | yes | yes | no | 89 | 2.6 | 95 | 4.6 | 94 | 5.5 |
| Ex 4 | yes | no | yes | 88 | 2.1 | 95 | −5.4 | 95 | −3.9 |
| Ex 5 | yes | yes | yes | 89 | 2.3 | 95 | −6.4 | 95 | −5.6 |

While the illustrative compositions, processes, reactors, methods and procedures have been described with particularity, it will be understood that various other modifications will be apparent to and can be readily made by those ordinarily skilled in the art without departing from the spirit and scope of our disclosure. Accordingly, we do not intend for the scope of the claims of this application to be limited to the examples and descriptions set forth in the application, but rather that the claims be construed as encompassing all novel and unobvious features of the embodiments covered by the claims, including equivalents of such embodiments.

What is claimed is:

1. A polyamide composition which comprises polyhexamethylene adipamide, polycaproamide, blends or copolymers thereof, the polyamide composition further including: (i) an optical brightener agent; and (ii) an anti-oxidant stabilizer comprising (A) copper halide antioxidant system; and/or (B) an organic antioxidant.

2. The polyamide composition according to claim 1, wherein the copper halide antioxidant system comprises copper iodide; copper bromide; copper acetate with or without potassium iodide and/or potassium bromide.

3. The polyamide composition according to claim 1, wherein the organic antioxidant comprises:
N,N′-hexane-1,6-diylbis(3-(3,5-ditertbutyl-4-hydroxyphenylpropionamide));
potassium tolylphosphinate;
sodium phenylphosphinate; and/or
tris (2,4-ditert-butylphenyl)phosphate.

4. The composition according to claims 1-3, wherein the optical brightener agent comprises distyrylbiphenyl type; 4,4′-bis-(sulfostyryl)-biphenyl disodium salt; a thiophenediylbisbenzoxazole type; 2,5-thiophenediylbis(5-tert-butyl-1,3-benzoxazole); a triazine type; a coumarin type; a benzooxazole type; a stilbene; and 2,2′-(1,2-ethenediyldi-4,1-phenylene) bisbenzoxazole.

5. The composition according to claim 1, wherein the optical brightener agent is 2,2′-(1,2-ethenediyldi-4,1-phenylene) bisbenzoxazole, which is present in the composition in the amount of about 5 to about 2000 parts per million by weight of the composition.

6. A yarn comprising at least a single filament comprising the polyamide composition according to claim 1.

7. The yarn according to claim 6, selected from the group consisting of a low oriented yarn, partially oriented yarn, fully drawn yarn, and flat drawn yarn with tenacity in the range of about 2 to about 12 gram/denier and elongation in the range of about 5 to about 90%.

8. An article of manufacture made from the yarn of claim 7.

9. An article of manufacture which includes the composition of claims 1-3.

10. An article of manufacture which includes the composition of claim 4.

11. A yarn comprising the polyamide composition of any of claims 1-3 having a b-colour in the range of −5 to −15 on the b* axis of the CIE rating.

12. A yarn comprising the polyamide composition of claim 4 having a b-colour In the range of −5 to −15 on the b* axis of the CIE rating.
